(19) United States
(12) Patent Application Publication
(10) Pub. No.: US 2017/0151573 A1
(43) Pub. Date: Jun. 1, 2017

(54) APPARATUS AND PROCESS FOR FINES RECOVERY

(71) Applicant: RECOV GLOBAL PTY LTD, Brisbane, Queensland (AU)

(72) Inventor: Ron COOMER, Brisbane, Queensland (AU)

(21) Appl. No.: 15/309,762

(22) PCT Filed: May 8, 2015
(86) PCT No.: PCT/AU2015/050223

§ 371 Date: Nov. 8, 2016

(30) Foreign Application Priority Data
May 8, 2014 (AU) 2014901705

(51) Int. Cl. B03B 7/00; B01D 33/03; B01D 21/26; B03B 5/34; B03B 9/00

(52) U.S. Cl. CPC B03B 7/00; B03B 5/34; B03B 9/005; B01D 21/262; B01D 33/03; B01D 21/267

(57) ABSTRACT

A transportable apparatus for separating and recovering fine particles from a slurry or a mixture comprising the fine particles and other particles; the apparatus comprising one or more fines separators and/or one or more fines classifiers, said separators and classifiers being mounted on a transportable frame for separating fine particles from the slurry, wherein the apparatus is operable for receiving the slurry from a discharge stream of an ore processing plant and/or the mixture being recovered from a tailings dam.

### TECHNICAL FIELD

The present invention relates to an apparatus and process for recovering fine particles such as but not limited to fine ore particles or fine coal particles or fine mineral particles.

### BACKGROUND ART

In recent years, much emphasis has been placed upon recovering fine ore particles including fine coal in preparation plants. In earlier periods, fine particles were considered to be a waste product and much were discarded as waste material. During those periods, prime emphasis was on the use of large, lump sized product. Much of product recovered from mines often contains particles that are small in size mixed with small pieces of rock and slate. In order to efficiently operate modern preparation plants, methods of cleaning fine coal to separate the useful fines from waste, rock, and slate materials have been developed. Prior art in this field of endeavour utilizes various types of separators to separate fines such as fine coal from contaminants which utilizes cyclones, spirals, vibrating screens and centrifuges by which fine coal can be cleaned and recovered for use in various energy or steel producing systems. However, the prior art recovery systems for fine ore particles including fine coal are usually very difficult and costly to retrofit especially to existing preparation plants, wash plants and ore processing facilities. Furthermore, the significant operational downtime involved in installing such fines recovery systems often counterbalances any benefits afforded by enhanced fines recovery methods known in the prior art. Therefore, there is a significant commercial need to at least reduce the cost and downtime delay in installation of such systems whilst also enhancing fines recovery from mining facilities. Further many newer preparation plants are fitted with fines recovery equipment which is often overloaded due to variations in the composition of the feed to these plants or because of equipment problems or incorrect operator settings causing imbalances in the flows within the plant resulting in many fine particles being unnecessarily discharged to waste. Further many preparation plants have limited capacity for dewatering the output of their fines circuits and often fines are discharged to waste in order to keep the plant at maximum production and prevent having to slow down the input feed to the plant so that all of the fines are recovered.

It will be clearly understood that any reference to prior art in this section does not constitute an admission that the prior art forms part of the common general knowledge in the art in Australia or in any other country.

### SUMMARY OF INVENTION

The present invention is directed to a transportable apparatus for separating and recovering fine particles such as fine ore particles or fine coal particles or fine mineral particles, which may at least partially overcome at least one of the abovementioned disadvantages or provide the consumer with a useful or commercial choice.

With the foregoing in view, the present invention in one form, resides broadly in a transportable apparatus for separating and recovering fine particles from a mixture comprising the fine particles and other particles; the apparatus comprising one or more fines separators and/or one or more fines classifiers, said separators and/or classifiers being mounted on or to a transportable frame wherein the apparatus is operable for receiving and processing the mixture and thereby separating and recovering a substantial part of the fine particles from the mixture.

Providing the transportable apparatus of the present invention allows users to advantageously utilise the apparatus for separating and recovering fines from the mixture of fine and other particles at locations such as tailings dams without the need for pumping or transporting the mixture or slurry containing the mixture over long distances. The apparatus of the present invention may also avoid the necessity to build and integrate a fines recovery plant into an existing ore, coal or mineral treatment plant.

In a preferred embodiment, the separator and/or classifier is configured for separating fine ore particles having a particle size of at least greater than 15 μm. More preferably, the separator and/or classifier is configured for separating fine ore particles having a particle size of at least greater than 20 μm and more preferably greater than 25 μm. The applicants have conducted numerous trials with embodiments of the present invention to find that separating ore particles in a size range of 15 μm to 40 μm, more preferably in the range of 20 μm to 35 μm results in recovery of fine ore particles such as (but not limited to) coal fines wherein up to 40% to 80% of the mass of the initial mass of the tailings is recovered in the form of coal particles which are suitable for use. The applicants have also realised that a part of the unrecovered fine particles, particularly the unrecovered coal fine particles having an particle size of less than 20 μm are not suitable for use due to relatively higher ash content (when compared with ash content of particles having a particle size of greater than 20 μm) and due to the relatively low mass (and associated weight) of the unrecovered particles. For example, fine coal particles having a size of less than 20 μm may blow away if placed in a stockpile during storage, collection or transportation. The non-limiting examples discussed in the foregoing sections further discuss the advantages of separating and recovering fine ore particles having a particle size of at least greater than 15 μm.

In some embodiments, the apparatus may be adapted for receiving the mixture in the form of a slurry comprising the mixture. For example the slurry may be formed by adding the mixture (comprising the fine particles and other particles) and a liquid medium such as water into a mixing chamber or a mixing tank. In some embodiments, the apparatus may be further provided with a primary screening device for screening the mixture received into the chamber for separating large sized particles. For example, the primary screening device may be adapted for preventing particles having a particle size of say greater than 5 mm from being received into the mixing chamber.

In some embodiments, the apparatus may further comprise means for agitating or inter-mixing contents of the mixing chamber.

In a preferred embodiment, the apparatus comprises at least one input cyclone separator mounted on or to the transportable frame. The input cyclone separator may be adapted to receive the slurry for separating the slurry into an overflow stream comprising a slurry containing relatively smaller particles and an underflow stream comprising larger particles. Preferably, the input cyclone separator may be adapted for being operated at a substantially constant pressure for separating fine ore particles having particle size of greater than 15 μm and more preferably greater than 20 μm and more preferably greater than 25 μm and more preferably greater than 30 μm. Providing the apparatus in such a preferred configuration allows for relatively high levels of separation and recovery of fine ore particles without conducting large and expensive processes such as flotation based separation and recovery methods.

In some embodiments, the apparatus may further include an additional screening device positioned relative to the input cyclone separator for screening larger particles from the underflow stream to obtain screened particles. Preferably, the additional screening device may comprise a vibrating sieve and may be operable to vibrate at high frequencies for receiving and screening the particles from the underflow stream of the input cyclone separator. The underflow stream may be subsequently dewatered by and dewatering the underflow stream to obtain a dewatered underflow comprising screened particles and a dewatered overflow.

It is important to appreciate that the present invention encompasses embodiments that include and exclude dewatering devices. For example, embodiments of the apparatus that exclude a dewatering unit may be adapted to be coupled with one or more of the flow circuits of an existing coal washing or ore washing or ore processing or coal processing facility. Therefore, the underflow from the input cyclone may be directed to an existing coal washing or coal processing facility thereby alleviating the requirement of providing a dewatering device in at least some embodiments.

In an alternative embodiment, in addition to the input cyclone as described in previous sections, the apparatus may further comprise at least one classifier positioned for receiving and classifying the screened particles by size or density to obtain classified particles.

In some embodiments, the apparatus may be adapted for separating and thickening fine particles from a mixture comprising the fine particles and other particles. For example, the apparatus may comprise a thickening cyclone separator positioned for receiving a stream comprising the classified particles and separating said stream into an overflow stream and an underflow substantially comprising a thickened stream comprising fine thickened particles.

Providing the transportable apparatus that is adapted for separating and thickening fine ore particles allows users to advantageously utilise the apparatus for separating and thickening the output from fines circuits in preparation plants to assist in increasing the capacity of the pre-existing dewatering equipment, in at least some embodiments and prevent fines from having to be unnecessarily discharged to waste or tailings streams. The apparatus may also be used to assist in the separation of fines in preparation plants typically associated with spiral circuits and assist in rebalancing the product flows in the plant to enable the plant to produce an increased rate of coal throughput without an excessive loss of fine particles.

The apparatus may also comprise a dewatering device to separate the fine particles from the underflow thickened stream of the thickening cyclone separator. The dewatering device may be provided in the form of a centrifugal separator. In alternative or additional embodiments, the dewatering device may be a belt filter or a vibrating screen and more preferably a high frequency vibrating screen.

The apparatus may be adapted to simultaneously receive and separate fine ore or fine coal particles from mixtures received from two different sources. For example, such an embodiment may allow users to simultaneously utilise the apparatus for separating and recovering fines from the mixture of fine ore particles and other particles at locations such as nearby tailings dams or stockpiles as well as recovering fines in the waste output from the processing plant before it is sent to the tailings area.

In some embodiments, the apparatus may further comprise a sump for receiving the classified particles and a clarifying fluid, such as water; and a pump for pumping the stream comprising the classified particles and the clarifying fluid to the thickening cyclone separator. In alternative or additional embodiments, the classifier may be a spiral classifier.

Furthermore, in some embodiments, the transportable apparatus may be adapted to either discharge the overflow from the separator or the screening device into an effluent tailings stream or to re-circulate some or all of the overflow to the one or more input cyclones.

In some embodiments, the classifier may be a reflux classifier comprising a fluidisation device for directing the received screened particles into a fluidisation chamber and separating the screened particles by size or density.

In an embodiment, the input cyclones may be in the form of de-sliming cyclones that assist in de-sliming the slurry received therein.

In some alternative embodiments, one or more of the separators may be optionally omitted from the apparatus. In an embodiment, the apparatus further comprises an input pump operable to draw the slurry comprising the mixture into the one or more separators or classifiers. The slurry may be drawn from an ore processing plant or from an ore tailings dam.

In alternative embodiments, the mixture may be excavated from a source such as a tailings dam by using excavating means provided either as a part of the apparatus or provided in addition to the apparatus.

In a second aspect, the invention provides a transportable apparatus for recovering fine particles from a mixture comprising the fine particles and other particles, the apparatus comprising: a transportable frame; one or more cyclone separation chambers of a first type mounted in or to the transportable frame, said one or more cyclone separation chambers adapted to receive an incoming stream containing the mixture, the one or more cyclone separation chambers being adapted for separating the stream into a first outgoing overflow stream comprising a slurry containing smaller separated particles and an underflow stream containing larger separated particles; a vibration screen positioned relative to the one or more of the first type of cyclone separation chamber for receiving the underflow stream from the first type of cyclone and screening the underflow stream to obtain an underflow comprising screened particles; a classifier positioned relative to the vibration screen for receiving the dewatered underflow and classifying the screened particles in the dewatered underflow by size or density to obtain classified particles; a sump positioned for receiving the classified particles from the classifier; and a cyclone separation chamber of a second type adapted to receive a stream comprising the classified particles from the sump for separating the stream comprising classified particles into an overflow output stream and an underflow output stream comprising thickened particles; a centrifugal separator for receiving the underflow output stream from the cyclone separation chamber of the second type for separating the thickened fines and a collector for collecting and directing the separated classified particles from the centrifugal separator to a stockpile.

In an embodiment, the apparatus further comprises a bypass valve for selectively stopping the flow of the incoming stream into the separators and classifiers and instead direct the discharge stream directly to waste or directly to a tailing stream.

In some embodiments, the transportable apparatus may further comprise more than one inlet for receiving the mixture from a discharge stream of an ore or coal processing plant and/or a tailings dam.

In some embodiments, the transportable apparatus may be adapted to position the separated and recovered fine particles onto a conveyor for conveying the recovered fine ore particles to a further processing step.

In further embodiments, the transportable apparatus may further comprise a safety platform mounted on or adjacent the transportable frame and positioned relative to the separators and classifiers for enabling personnel to operate and maintain the separators and/or classifiers.

In further embodiments, the transportable apparatus may further comprise a control system for controlling the operation of the separators and classifiers. In an embodiment, the control system comprises a programmable logic controller and a motor control centre.

In some embodiments, the transportable apparatus may further comprise an electrical power generator, wherein the power generator is preferably mounted on the transportable frame. In alternative embodiments, the apparatus may be operable to be connected to an external electrical power source.

In some embodiments, the transportable frame comprises an enclosed housing for substantially enclosing the mounted one or more classifiers and/or one or more separators. Preferably, the housing comprises a container for enclosing and securing the mounted one or more classifiers and/or one or more separators. The container, in at least some embodiments, may take the form of a shipping container, thereby facilitating convenient transportation of the apparatus by transportation means adapted for transporting shipping containers. The components of the apparatus may be mounted to the floor and/or to the walls of the container.

In a third aspect, there is provided a process for separating and recovering fine particles from a slurry comprising a mixture including the fine particles and other particles; the process comprising the step of directing a slurry comprising the fine particles discharged from an ore processing plant or tailings dam to an apparatus as described herein.

In a fourth aspect, the present invention provides a process for separating and recovering fine particles from a mixture comprising the fine particles and other particles, the process comprising the steps of separating or classifying the fine particles having a particle size of at least greater than 15 μm from the other particles and recovering the separated or classified fine particles.

More preferably, the process may further comprise the step of separating fine ore particles having particle size of at least greater than 20 μm and more preferably greater than 25 μm or even greater than 30 μm.

The applicants have conducted numerous trials with embodiments of the present invention to find that separating ore particles in a size range of 15 to 50 μm and more preferably in the range of 20 to 45 μm and still more preferably in the range of 20 μm to 35 μm or more preferably in the range of 20 μm to 30 μm results in recovery of fine particles such as (but not limited to) coal fines wherein of 40% to 80% of the mass of the initial mass of the tailings is recovered in the form of fine coal particles which are suitable for further use. The applicant has also realised that a part of the unrecovered fine particles, particularly the unrecovered coal fine particles having a particle size of less than 15 or less than 20 or less than 25 μm or less than 30 μm is not suitable for use due to high ash content and due to the relatively low mass (and associated weight) of the unrecovered particles. For example, fine coal particles having a size of less than 15 μm may blow away if placed in a stockpile during storage, collection or transportation. The non-limiting examples discussed in the foregoing sections further discuss the advantages of separating and recovering fine particles having a particle size of at least greater that 15 μm.

In at least some embodiments, the step of separating or classifying further comprises steps of forming a slurry comprising the mixture and subsequently directing the slurry to one or more fines separators and/or one or more fines classifiers.

In some embodiments of the process, at least one of the separators comprises a cyclone separator such that the step of separating comprises directing the slurry to the cyclone separator and separating the slurry into an overflow stream comprising a slurry containing ultrafine particles having a particle size of less than or equal to 15 μm and an underflow stream comprising larger particles having a particle size of equal to or greater than 15 μm.

In some further embodiments of the process, at least one of the separators comprises a cyclone separator such that the step of separating comprises directing the slurry to the cyclone separator and separating the slurry into an overflow stream comprising a slurry containing ultrafine particles having a particle size of less than or equal to 20 μm and an underflow stream comprising larger particles having a particle size of equal to or greater than 20 μm.

In some embodiments, the separating or classifying step comprises separating or classifying of the fine particles having a particle size of less than 1000 μm and more preferably less than 500 μm.

In some further embodiments, at least one of the separators comprises a cyclone separator such that the step of separating comprises directing the slurry to the cyclone separator and separating the slurry into an overflow stream comprising a slurry containing smaller particles having a particle size of less than or equal to 25 μm and an underflow stream comprising larger particles having a particle size of equal to or greater than 25 μm.

The step of directing the slurry to the cyclone separator may be carried out under a substantially constant pressure. This may be achieved by using a pump controlled by a variable speed drive responsive to the pressure at the input to the cyclone.

In some embodiments, the process may further comprise a step of receiving a stream comprising the particles in the underflow stream and directing the stream into a thickening cyclone and separating the stream into an overflow stream and an underflow thickened stream comprising fine thickened particles.

In some embodiments, the process may also include a step of dewatering the underflow thickened stream to separate fine particles from the underflow thickened stream.

In some embodiments, the process may exclude the dewatering step. Instead, the process may comprise forming a processing stream comprising the recovered particles and pumping the processing stream to a recovery treatment step. It is important to appreciate that the present invention encompasses embodiments that include and exclude dewatering devices. For example, embodiments of the process that exclude a dewatering step may be adapted to be coupled with one or more of the flow circuits of an existing ore washing or ore processing or coal washing or coal processing facility. Therefore, the underflow from the input cyclone may be directed to the existing ore washing or ore processing facility.

In some embodiments, the process may further comprise the step of adding a binding agent to the separated or classified ore particles or coal particles for binding the separated or classified particles before the recovering step. The binding agent or the binder may be added to either the underflow output slurry from the cyclone or it can be added as part of the dewatering process (eg added as a spray onto the recovered product as it is being dewatered on a vibrating screen).

In at least some process embodiments, some of the overflow water from the cyclones may be recirculated back to the mixing chamber to break up the fines when loaded by an excavator into the mixing chamber. A pump with an agitation arrangement such as a spray arrangement to direct the overflow water may be used for breaking large sized ore particles being introduced into the mixing chamber. A method of level control may be employed to keep the level of the slurry in the mixing tank at a relatively constant level by way of a regulating valve arrangement to ensure the amount of slurry being pumped from the tank is being replaced with the excess overflow from the cyclones then being directed to waste.

In an embodiment, the apparatus may be adapted to be lifted by a crane. The transportable frame may be provided with brackets or shackles for assisting in a lifting operation.

In some embodiments the transportable apparatus may further comprise an analysing device for measuring the quantity of or analysing composition of the separated and/or recovered fine particles. Preferably, the analysing device is adapted for analysing ash composition in the separated and/or recovered fine particles.

In some embodiments the transportable apparatus may further comprise a remote monitoring and control system which may utilise a web browser to remotely monitor, manage and record the operation of the apparatus in real time.

In some embodiments, the apparatus may be provided with means for enabling remote monitoring and controlling operation of the apparatus. For example, the apparatus may be operated at a remote location by way of a control interface in the form of a web browser provided on a computer located away from the apparatus.

Preferably, the apparatus may further comprise communication means for communicating operational parameters and/or abnormalities over a wired and/or wireless communication network. For example, the the apparatus may be provided with a remote monitoring and control system having SMS capability to send alarm messages to personnel, said messaging preferably being controlled by a programmable roster.

In a further aspect, there is provided a system for separating and recovering fine particles from a mixture comprising the fine particles and other particles; the system comprising: a remotely located mixing apparatus for receiving the mixture into a mixing chamber and forming a slurry therein; a pumping apparatus for pumping the slurry from the mixing apparatus to a separation apparatus located away from the mixing apparatus; wherein the separation apparatus comprises one or more fines separators and/or one or more fines classifiers, said separators and/or classifiers being mounted on a transportable frame wherein the separation apparatus receives and processing the slurry for separating and recovering a substantial part of the fine particles from the slurry.

In an embodiment, the separation apparatus is adapted to receive an additional stream of slurry from an existing coal or ore processing facility such that the separation apparatus simultaneously receives and processes the slurry received from the remotely located mixing apparatus and from the coal or ore processing facility.

Any of the features described herein can be combined in any combination with any one or more of the other features described herein within the scope of the invention.

### BRIEF DESCRIPTION OF DRAWINGS

Various embodiments of the invention will be described with reference to the following drawings, in which:

FIG. 1 is a first perspective view of a transportable apparatus for recovering fine particles in accordance with a first embodiment of the present invention.

FIG. 2 is a second perspective view of the transportable apparatus for recovering fine particles in accordance with the first embodiment of the present invention.

FIG. 3 is a schematic diagram illustrating components of the apparatus of the first embodiment and the flow path of material flowing through the components.

FIG. 4 is a first perspective view of a transportable apparatus for recovering fine particles in accordance with a second embodiment of the present invention.

FIG. 5 is a second perspective view of a transportable apparatus for recovering fine particles in accordance with the second embodiment of the present invention.

FIG. 6 is an internal perspective view of a separation unit of the second embodiment of the present invention.

FIG. 7 is a first perspective view of the mixing unit of the second embodiment of the present invention.

FIG. 8 is a second perspective view of the mixing unit of the second embodiment of the present invention.

FIG. 9 is a schematic diagram illustrating components of the apparatus of a preferred version of the second embodiment and the flow path of material flowing through the components of the apparatus.

FIG. 10 is a perspective view of a transportable apparatus for recovering fine particles in accordance with a third embodiment of the present invention.

FIG. 11 is an internal perspective view of a separation unit of the third embodiment of the present invention.

FIG. 12 is an example of representation of the results of a size distribution analysis in a Rosin Rammler diagram for a first sample in accordance with Example 1.

FIG. 13 is an example of representation of the results of a size distribution analysis in a Rosin Rammler diagram for a second sample in accordance with Example 1.

FIG. 14 is an example of representation of the results of a size distribution analysis in a Rosin Rammler diagram for a third sample in accordance with Example 2.

FIG. 15 is an example of representation of the results of a size distribution analysis in a Rosin Rammler diagram for a fourth sample in accordance with Example 2.

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

### DESCRIPTION OF EMBODIMENTS

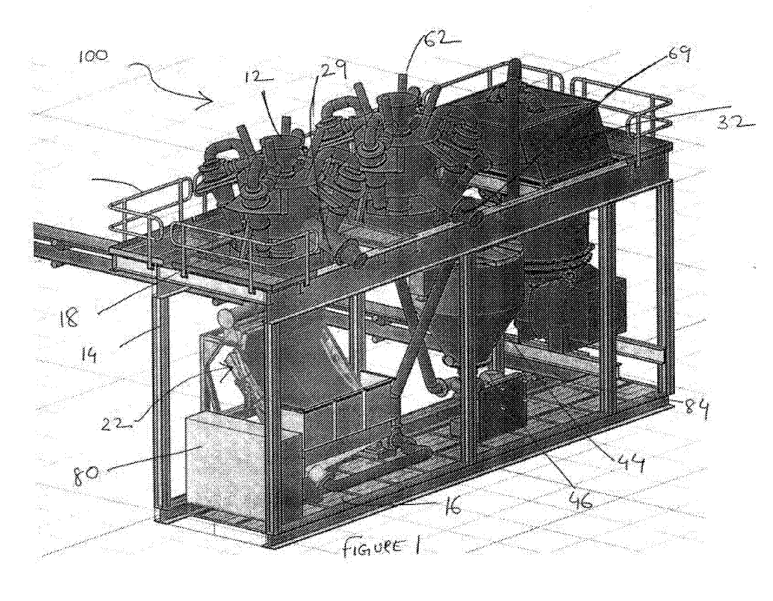

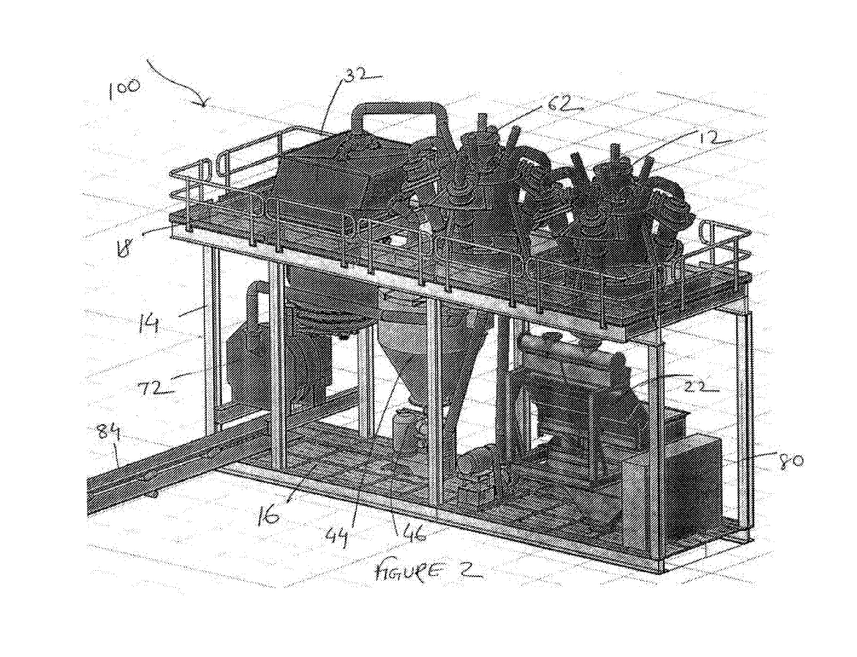

Referring to FIGS. 1 to 3, a transportable fines recovery apparatus 100 comprises a transportable frame structure 14. The frame structure 14 comprises a base 16 and a raised platform 18. The frame structure 14 is preferably has a length of less than 12 m and a width of less than 3 m. Such dimensions enable the apparatus to be transported by being loaded onto a tray of a standard truck. The apparatus 100 is designed to be fitted into an existing ore processing plant, such as a coal washing plant. In coal washing plants, a fines slurry is generated that comprises fine coal particles. This fines slurry is typically disposed by methods such as pumping to a tailings dam, notwithstanding that the fines slurry may contain recoverable coal particles. Thus the apparatus 100 includes an inlet pipe 10 that receives a fines slurry from the coal washing plant. Providing an inlet 10 that is adapted for receiving a fines slurry discharged from a coal washing plant is advantageous because it enables the apparatus 100 to be readily installed at or adjacent the coal washing facility without significant delays. The inlet 10 by way of example only may comprise a quick-install plumbing fitting that can readily fit onto the discharge tailings stream of the existing coal washing facility The fines slurry with coal fines in a liquid slurry is received into one or more input cyclones 12 mounted on the raised platform 18 via inlet 10. The input cyclones 12 are preferably in the form of de-sliming cyclones. The slurry may either be fed into the input cyclones 12 by a conventional pumping means (not shown) or be supplied from a preparation plant into the input cyclone 12 under gravitational effect. A skilled user would readily appreciate that the number of input cyclones 12 used for utilising the apparatus of the present invention may be advantageously varied in accordance with the requirements of the fines recovery operation being carried out. The input cyclones 12 may be in the form of commercially available cyclones preferably having a diameter ranging between 8 to 15 inches. These input cyclones 12 size the coal fines in the slurry and separation of fines. The underflow stream comprising separated coal fines is directed onto a high frequency vibrating screen apparatus 22 through flow line 28. The separated coal fines fed to the vibrating screen apparatus 22 represent a larger size fraction of the coal particles fed to the apparatus 100. Overflow from the input cyclones 12 is discharged to a tailing stream 52 through flow line 29. The overflow that exists via line 29 represents the finer particles of coal fines of a size less than a threshold size (for example 2 mm-2.5 mm). Fines with a size of greater than the threshold size are directed to the underflow from the de-sliming cyclone separator. Particles smaller than the threshold size are discharged into the overflow stream of the cyclone 12. The particles in the overflow stream are typically thought of as impractical to use and thus may be discharged into a tailings stream. The high frequency vibrating apparatus 22 screens the separated coal fines and discharges the underflow comprising the screened fines into a reflux classifier 32 though flow line 39. The overflow from the vibrating screen 22 is discharged from the high frequency vibrating screen 22 to the tailing stream 52 via flow line 42.

The screened coal fines are directed by flow line 39 into the reflux classifier 32. The reflux classifier may be in the form of commercially available Ludowici® Reflux classifiers that use gravity based separation for separating the screened coal fines on the basis of particle size and particle density. The reflux classifier 32 comprises a mixing chamber (not shown) that receives a slurry comprising the screened coal fines received from the underflow of the vibrating screen 22. The screened coal fines in the mixing chamber undergo a sorting process due to the combined effect of gravitational force and up-flow of fluidisation of water entering the classifier. At the bottom of the mixing chamber, a bed of high density coal fines is formed. These high density coal fines are kept in suspension by the incoming fluidisation water coming into the mixing chamber of the classifier 32. These high density coal fines sink to the bottom of the mixing chamber under the effect of gravity and are deposited at a location that is advantageously provided with a central underflow valve (not shown) that controls the release of these high density coal fines transferred from the reflux classifier 32 to a reflux sump 44 which is in the form of a holding tank. The reflux classifier has the capacity to classify fines on the basis of particle size down to a size of 25 μm.

A further separation process is carried out by supplying clarifying fluid in the form of clean water into the reflux sump 44 thereby forming a slurry comprising the classified coal fines and water. This slurry is directed to thickening cyclones 62 via flow line 65 by using a pump 46 that draws the slurry from the sump 44 to the thickening cyclones 62. The thickening cyclones 62 receive the slurry fed from flow line 65 and separate the incoming slurry into an underflow 67 comprising thickened coal fines and an overflow stream. The overflow stream is once again directed to the tailings stream 52 by overflow line 69. The underflow stream is subsequently fed into a centrifuge unit 72 whereby the thickened coal fines are separated from the water by centrifugation. The centrifuge unit 72 may take the form of conventional centrifuge units such as the Ludowici HFC1300 fine coal centrifuge configured for fine coal processing. Such centrifuge units typically comprise a scrolled basket type configuration. A differential speed of the scroll with the reference to the basket (holding the thickened coal fines) creates high G forces which forces surface water through the apertures of the basket whilst the coal fines are retained on the basket. The centrifuged coal fines are discharged from the centrifuge and positioned onto a conveyor apparatus 84 to be transported to a stockpile (not shown).

The cyclone separators (12 & 62), the reflux classifier 32, the centrifuge unit 72 and the several pumps are typically powered by electrical power that is controlled by a controlling unit 80 mounted on the base of the transportable frame 14. The power source may either be mounted on the transportable frame in the form of an on-board power generator or alternatively an external power source may be plugged into the controlling unit of the apparatus to power the separators and classifiers mounted on the frame. In an advantageous modification, the apparatus is also provided with a bypass valve positioned for temporarily stopping the flow of the slurry into the input cyclones 12. This assists in carrying repairs on the apparatus 100 whilst not effecting the standard operation of the ore processing facility discharging the coal fines in the slurry.

In further advantageous embodiments or improvements, the centrifuged coal fines may be directed to a further refining process for further processing of the centrifuged coal fines at the coal washing plant (back to the coal washing circuit) or other fines processing plants.

In further embodiments, the overflow stream from the separators or classifiers may not be directed to a tailings stream and instead be directed for further processing to the coal (back to the coal washing circuit) washing plant or yet another fines processing plant.

Providing an apparatus comprising the cyclonic separators, classifiers and pumping unit mounted on a transportable frame 14 presents several key advantages towards the working of the present invention. First of all, the apparatus of the present invention is transportable which enables off-site construction of the fines recovery apparatus 100 and subsequently enables retrofitting of this apparatus 100 to pre-existing preparation plants or ore processing/mining facilities. As explained earlier, this is carried out by directing or pumping the discharge stream of an existing preparation plant into the input cyclones 12 of the apparatus 100. Such a transportable configuration of the fines recovery apparatus also requires much less time for installation than existing or known methods. Furthermore, some of the conventional methods require carrying out relatively expensive modification or customisation to the existing processing facility before a fines recovery operation can be carried out. Carrying out expensive modifications also renders the preparation plant/mining facility inoperable for long periods of time (down-time). Such periods of inoperability can have serious financial implications due to non-productivity of the preparation plant during the down-time. As a result, any benefit derived from an effective fines recovery process is negated by the non-productivity during down-time. The present invention significantly reduces down-time as a result of its transportable frame-mounted configuration of the fines recovery apparatus. The apparatus of the present invention is also suitable for use with spirals in the fines circuits of an existing preparation plant with a processing capacity of up to 600 tonnes per hour to provide improved separation and eliminate blockages, spillages and the need to manually adjust for different product types.

In recently conducted trials, the applicants have reported fines recovery rates that result in overall improvement in yield of 3% to 4% with the overall costs of installing the apparatus of the present invention being less than ¼th when compared with any known fines recovery systems currently available in the market.

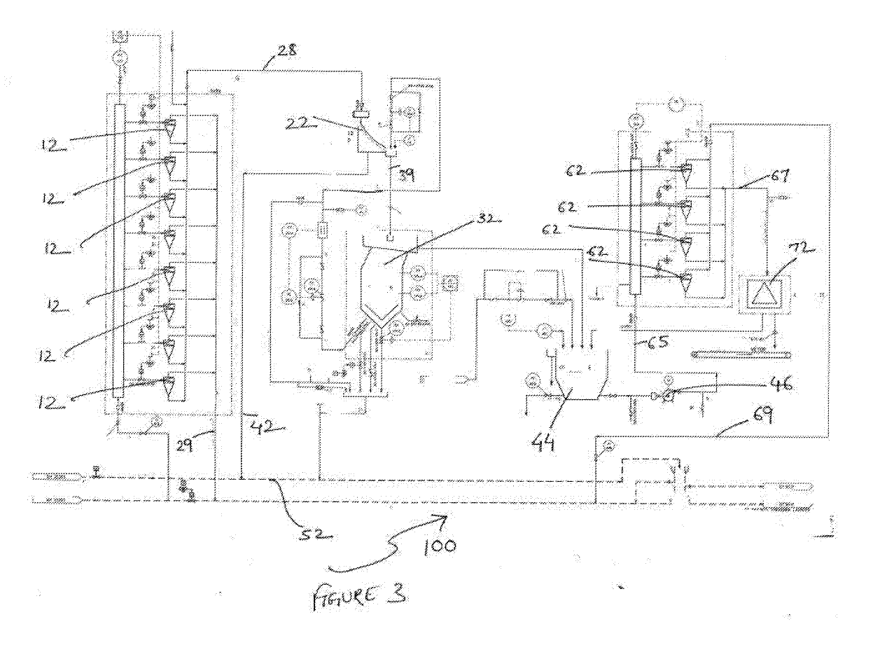

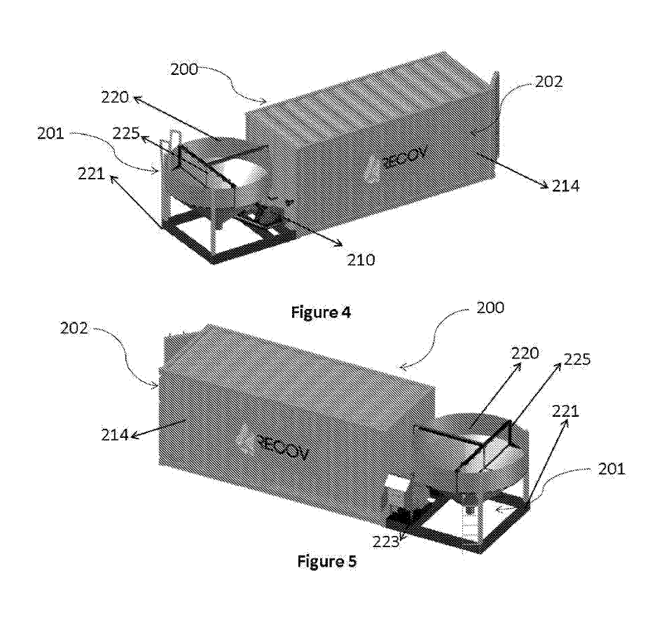

Referring to FIGS. 4 to 8, a second embodiment of a transportable fines recovery apparatus 200 is illustrated. Like reference numerals denote like features that have been previously discussed in preceding sections. The apparatus 200 comprises of a mixing unit 201 and a separation unit 202.

The separation unit 202 comprises a transportable container structure 214 that includes a container with an enclosed internal space. The container structure 214 provides a transportable frame for mounting a separation and recovery unit therein.

The mixing unit 201 comprises a mixing tank 220 positioned on a tank frame 221 is provided for receiving a mixture of ore fines and other particles from a tailings dam T1. For example, an excavator 227 may be utilised for excavating the mixture from a tailing dam and introducing the mixture into the mixing tank 220. The mixing tank is also provided with a vibration screen 225 for preferably (or optionally) screening particles having a particle size of greater than 3 mm. The mixture may be mixed with water pumped into the mixing tank by way of a pump 223 positioned on the tank frame 220. A slurry comprising the mixture is formed in the mixing tank 220 and directed or pumped into the separation and recovery unit 230 positioned inside the container 214.

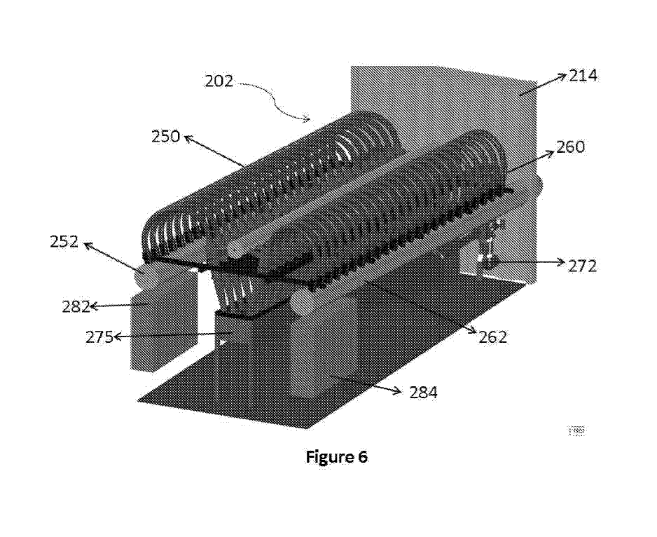

Thus the separation and recovery unit 202 includes an inlet pipe 210 that receives a fines slurry from the mixing tank 220. The inlet 210 (by way of example only) may comprise a quick-install plumbing fitting that can readily fit onto the complementary plumbing fittings provided at an outlet of the mixing tank 220. Alternatively or additionally, the inlet 210 may also be adapted to receive a discharge tailings stream from an existing coal washing facility. Referring to FIG. 6, the separation and recovery unit 202 comprises two rows of cyclones 250 and 260, each row comprising twelve cyclones. It will be understood that the present invention is no way limited by the number of cyclones. Each row of cyclones 250, 260 may be configured to receive slurries from different sources. For example, The first row of cyclones may be configured to receive slurries (which would otherwise be directed to tailing streams) containing fine coal particles from an existing coal washing or processing facility by way of a pumping assembly 272 driven by a variable speed drive 282. The second row of cyclones 260 may be configured to receive slurries from a mixing unit 201 positioned in close proximity to a tailings dam by way of a pumping assembly 272 driven by a variable speed drive 284. Therefore, the apparatus is adapted, at least in some operational configurations, to be able to separate and classify fines from two different sources. Each row of cyclones may be adapted for receiving the slurry with coal fines suspended in the liquid-phase slurry may be received into the input cyclones 12 mounted within the container 214 and may be adapted to process up to 600 cubic metres of slurry per hour and recover up to 35 tonnes of fines per hour (depending on the amount of fines in the mixture). The input cyclones may preferably be in the form of de-sliming cyclones. The input cyclones may also be in the form of commercially available cyclonic separators. These input cyclones may be configured for sizing and separating the coal fines in the slurry. Preferably, the cyclones may be configured for separating particles having a particle size of greater than 15 μm and more preferably greater than 20 μm and still more preferably greater than Each row of cyclones 250 and 260 would separate the respective slurries received into an underflow stream 275 (comprising the particles having a particle size of greater than 20 μm) and an overflow stream 252 and 262 (comprising particles having a particle size of less than 20 μm) respectively. Two different versions or embodiments of the apparatus 200 may be provided.

In a first version, say 200A, a dewatering unit is not provided. A series of cyclones form the main component of the separation and recovery unit 230 and may receive the incoming stream from the mixing tank 220 via flow line 227. This stream may be separated into a first outgoing overflow stream 232 comprising a slurry containing particles having a particle size of less than 20 μm which is directed to a tailings dam T2. An underflow stream 234 substantially containing ore particles having a particle size of greater than or equal to 20 μm may be suitably directed to one or more of the flow circuits of an existing ore washing or ore processing facility 250. The overflow stream 232 may be discharged in a manner as previously described in previous sections. Therefore, the first version 200A may be particularly suitable for use under application whereby the underflow stream can be directly pumped from the container 214 to an existing ore washing or ore processing facility 250.

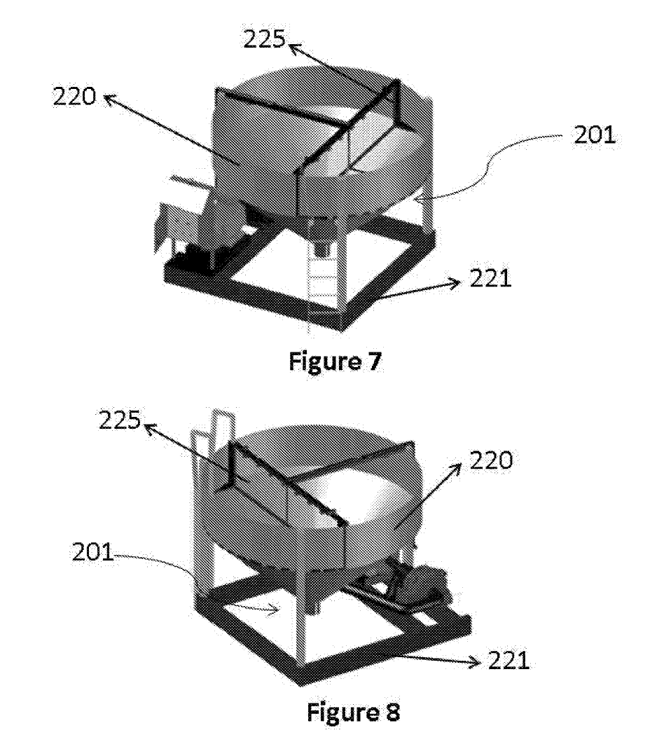

Referring to FIGS. 7 and 8, the mixing unit 201 may be adapted to be positioned away from the separation unit 202. For example, the mixing unit 201 may be positioned in close proximity to a tailings dam in order to be adapted to receive tailings into the mixing chamber 220. The slurry formed in the mixing chamber 220 may be pumped to a separation and recovery unit 202 located away from the mixing unit 201. Therefore, the invention is in no way limited to providing the mixing unit 201 in close proximity to the separation and recovery unit 202.

FIG. 7 illustrates yet another embodiment of the first version 200A in the form of a trailer mounted apparatus 200A′. Like reference numerals denote like features as previously discussed. The container structure 214 is advantageously mounted onto a trailer which is in turn adapted to be towed by a vehicle thereby allowing easy transportation of the apparatus 200A.

In a second version, say 200B, a dewatering unit may be provided as a part of the apparatus 200B. The underflow stream comprising separated coal fines may be directed from the cyclone 12 onto a high frequency vibrating screen apparatus 22 through flow line 28. The separated coal fines fed to the vibrating screen apparatus 22 represent a larger size fraction of the coal particles fed to the apparatus 200B, the ultrafine particles being separated and reporting to the cyclone overflow stream. The high frequency vibrating apparatus 22 screens the separated coal fines and discharges the underflow comprising the screened fines into a reflux classifier 32. The overflow from the vibrating screen 22 is discharged in a manner as discussed in previous sections. The reflux classifier 32 receives a slurry comprising the screened coal fines received from the underflow of the vibrating screen 22. The screened coal fines in the reflux classifier 32 undergo a sorting process due to the combined effect of gravitational force and up-flow of fluidisation of water entering the classifier and high density coal fines sink to the bottom of the classifier 32. The reflux classifier 32 classifies fines on the basis of particle size down to a size of 0.025 mm.

Thickening cyclones 62 may once again be used in conjunction with the reflux classifier 32 in a manner as previously discussed to obtain an underflow comprising thickened coal fines. Furthermore, a centrifuge unit 72 may also be utilised for separating the thickened coal fines from the water in the underflow. The cyclonic separators (12 &62), the reflux classifier 32, the centrifuge unit 72 are conveniently and securely housed within the container 214 and allow the apparatus to be stationed at remote location without any risk of being mishandled or accessed by unauthorised personnel.

### Example 1

In a first example, tailing samples obtained from a tailings dam associated with a coking coal mine in central Queensland, Australia were analysed for separation and recovery by the apparatus and process disclosed and discussed in previous sections.

Size analysis characteristics were analysed by ACIRL Quality Testing Services Pty Ltd at Queensland Australia.

Table 1 shown below lists the results for a first sample, sample 1.

TABLE 1

| Size Analysis | | | | Cumulative % | | Cumulative % | |
|---|---|---|---|---|---|---|---|
| Raw | Fractional % | | Size | Mass | Ash | Mass | Ash |
| (mm) | Mass | Ash | (mm) | Passing | | Retained | |
| ∞ | | | | 100 | 19.5 | 0 | |
| +0.250 | 4.6 | 3.7 | 0.250 | 95.4 | 20.3 | 4.6 | 3.7 |
| −0.250 + 0.125 | 9.9 | 4.4 | 0.125 | 85.5 | 22.1 | 14.5 | 4.2 |
| −0.125 + 0.063 | 17.7 | 5.9 | 0.063 | 67.8 | 26.4 | 32.2 | 5.1 |
| −0.063 + 0.045 | 7.1 | 7.4 | 0.045 | 60.7 | 28.6 | 39.3 | 5.5 |
| −0.045 + 0.038 | 2.8 | 10.4 | 0.038 | 57.9 | 29.5 | 42.1 | 5.9 |
| −0.038 + 0.020 | 11.6 | 13.5 | 0.020 | 46.3 | 33.5 | 53.7 | 7.5 |
| −0.020 | 46.3 | 33.5 | | 0 | | 100 | 19.5 |

The results from an analysis of sample 1, also depicted graphically in FIG. 8, indicate that separation and recovery of tailing samples with a particle size of greater than 0.02 mm (20 μm) results in recovering 53.7% of the initial masse of the tailing sample and was also found to have a relatively ash content of 7.5%. Similarly recovering tailing samples with a particle size of greater than 0.038 mm (38 μm) resulted in recovering 42.1% of the tailing sample which was found to have a relatively low ash content of 5.9%. Therefore, the applicants have theorised that separating and recovering particles from tailing dams having a particle size of equal to or greater than 0.02 mm (20 μm) and or greater than 0.038 (38 μm), in at least some embodiments, results in recovering a relatively high percentage of the initially sampled tailings particles which advantageously have a relatively low ash content.

Another sample obtained from the tailings dam associated with the coking coal mine in central Queensland, Australia was also analysed. Table 2 shown below lists the results obtained from testing sample 2.

TABLE 2

| Size Analysis | | | | Cumulative % | | Cumulative % | |
|---|---|---|---|---|---|---|---|
| Raw | Fractional % | | Size | Mass | Ash | Mass | Ash |
| (mm) | Mass | Ash | (mm) | Passing | | Retained | |
| ∞ | | | | 100 | 20.8 | 0 | |
| +0.250 | 13.2 | 7.1 | 0.250 | 86.8 | 22.9 | 13.2 | 7.1 |
| −0.250 + 0.125 | 11.8 | 12.7 | 0.125 | 75.0 | 24.5 | 25.0 | 9.7 |
| −0.125 + 0.063 | 11.8 | 13.2 | 0.063 | 63.2 | 26.6 | 36.8 | 10.9 |
| −0.063 + 0.045 | 7.4 | 11.4 | 0.045 | 55.8 | 28.6 | 44.2 | 10.9 |
| −0.045 + 0.038 | 0.8 | 9.9 | 0.038 | 55.0 | 28.9 | 45.0 | 10.9 |
| −0.038 + 0.020 | 13.3 | 13.7 | 0.020 | 41.7 | 33.7 | 58.3 | 11.6 |
| −0.020 | 41.7 | 33.7 | | 0 | | 100 | 20.8 |

The results from an analysis of sample 2 also depicted graphically in FIG. 9 indicate that separating and recovering tailing samples with a particle size of greater than 0.02 mm (20 μm) results in recovering 58.3% of the initial mass of the tailing sample and was found to have a relatively ash content of 11.6%. Similarly recovering tailing samples with a particle size of greater than 0.038 mm (38 μm) resulted in recovering 45.0% of the tailing sample which was found to have a relatively low ash content of 10.9%. Therefore, once again, separating and recovering particles from tailing dams having a particle size of equal to or greater than 0.02 mm (20 μm) and or greater than 0.038 mm (38 μm), in at least some embodiments, results in recovering a relatively high percentage of the initially samples tailings particles which advantageously have a relatively low ash content.

### Example 2

In a second example, tailing samples obtained from a tailings dam associated with a steaming coal mine in the Hunter Valley, New South Wales, Australia were analysed for separation and recovery by the apparatus and process disclosed and discussed in previous sections.

Size analysis characteristics were analysed by ACIRL Quality Testing Services Pty Ltd at Queensland Australia.

Table 3 shown below lists the results for a third sample, sample 3.

TABLE 3

| Size Analysis | | | | Cumulative % | | Cumulative % | |
|---|---|---|---|---|---|---|---|
| Raw | Fractional % | | Size | Mass | Ash | Mass | Ash |
| (mm) | Mass | Ash | (mm) | Passing | | Retained | |
| ∞ | | | | 100 | 51.3 | 0 | |
| +0.250 | 0.8 | 10.1 | 0.250 | 99.2 | 51.4 | 0.8 | 10.1 |
| −0.250 + 0.125 | 4.1 | 6.5 | 0.125 | 95.1 | 53.3 | 4.9 | 7.1 |
| −0.125 + 0.063 | 10.4 | 9.2 | 0.063 | 64.7 | 58.8 | 15.3 | 8.5 |
| −0.063 + 0.045 | 5.7 | 18.4 | 0.045 | 79.0 | 61.7 | 21.0 | 11.2 |
| −0.045 + 0.038 | 3.1 | 26.1 | 0.038 | 75.9 | 63.1 | 24.1 | 13.1 |
| −0.038 + 0.020 | 8.2 | 26.2 | 0.020 | 67.7 | 67.6 | 32.3 | 16.4 |
| −0.020 | 67.7 | 67.6 | | 0 | | 100 | 51.1 |

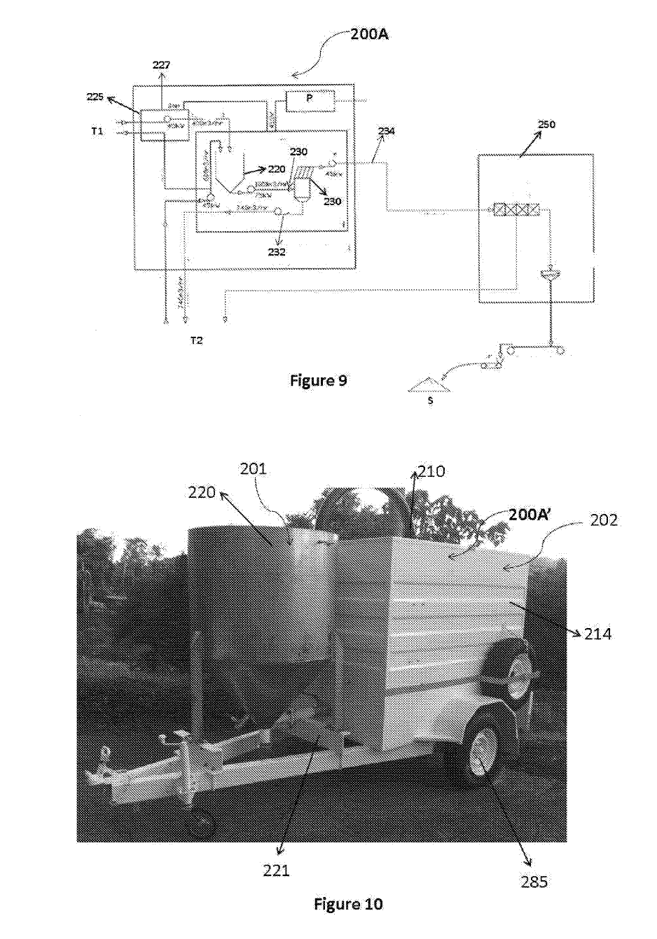

The results from an analysis of sample 3 also depicted graphically in FIG. 10 indicate that separation and recovery of tailing samples with a particle size of greater than 0.02 mm (20 μm) result in recovering 32.3% of the initial mass of the tailing sample and was found to have a relatively low ash content of 16.4%. Similarly recovering tailing samples with a particle size of greater than 0.038 mm (38 μm) resulted in recovering 24.1% of the tailing sample which was found to have a relatively low ash content of 13.1%. Therefore, the applicants have theorised that separating and recovering particles from tailing dams having a particle size of equal to or greater than 0.02 mm (20 μm) and or greater than 0.038 mm (38 m) in at least some embodiments, results in recovering a relatively high percentage of the initially samples tailings particles which advantageously have a relatively low ash content.

Another sample obtained from the tailings dam associated with the steaming coal mine in the Hunter Valley, New South Wales, Australia was analysed. Table 4 shown below lists the results obtained from testing sample 4.

TABLE 4

| Size Analysis | | | | Cumulative % | | Cumulative % | |
|---|---|---|---|---|---|---|---|
| Raw | Fractional % | | Size | Mass | Ash | Mass | Ash |
| (mm) | Mass | Ash | (mm) | Passing | | Retained | |
| ∞ | | | | 100 | 44.9 | 0 | |
| +0.250 | 1.2 | 30.6 | 0.250 | 98.8 | 45.1 | 1.2 | 30.6 |
| −0.250 + 0.125 | 5.7 | 6.2 | 0.125 | 93.1 | 47.5 | 6.9 | 10.4 |
| −0.125 + 0.063 | 10.7 | 9.5 | 0.063 | 82.4 | 52.4 | 17.6 | 9.9 |
| −0.063 + 0.045 | 7.2 | 13.3 | 0.045 | 75.2 | 56.2 | 24.8 | 10.9 |
| −0.045 + 0.038 | 3.7 | 17.6 | 0.038 | 71.5 | 58.2 | 28.5 | 11.7 |
| −0.038 + 0.020 | 11.7 | 35.0 | 0.020 | 59.8 | 62.7 | 40.2 | 18.5 |
| −0.020 | 59.8 | 62.7 | | 0 | | 100 | 44.3 |

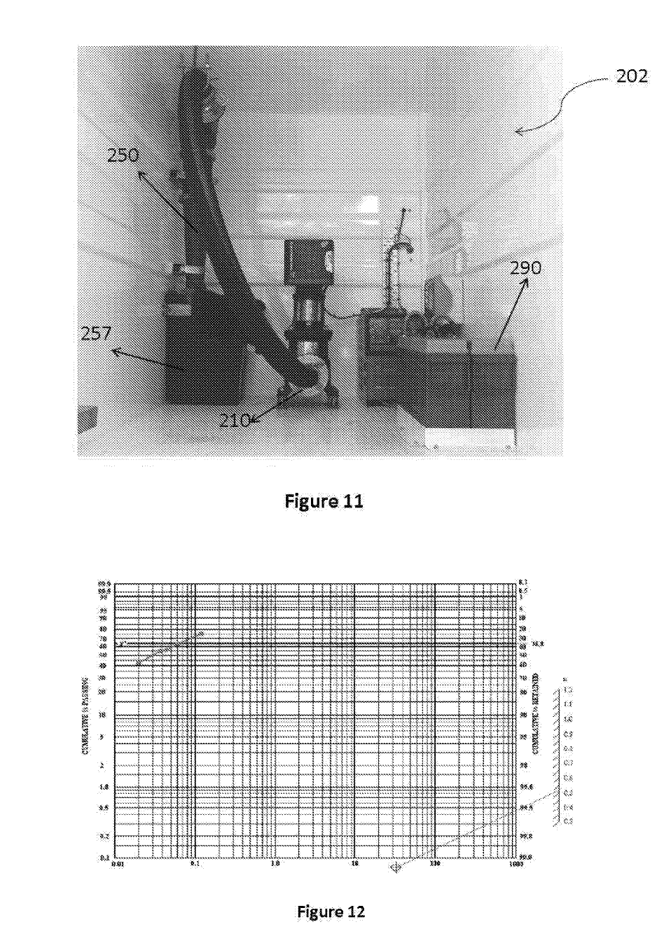

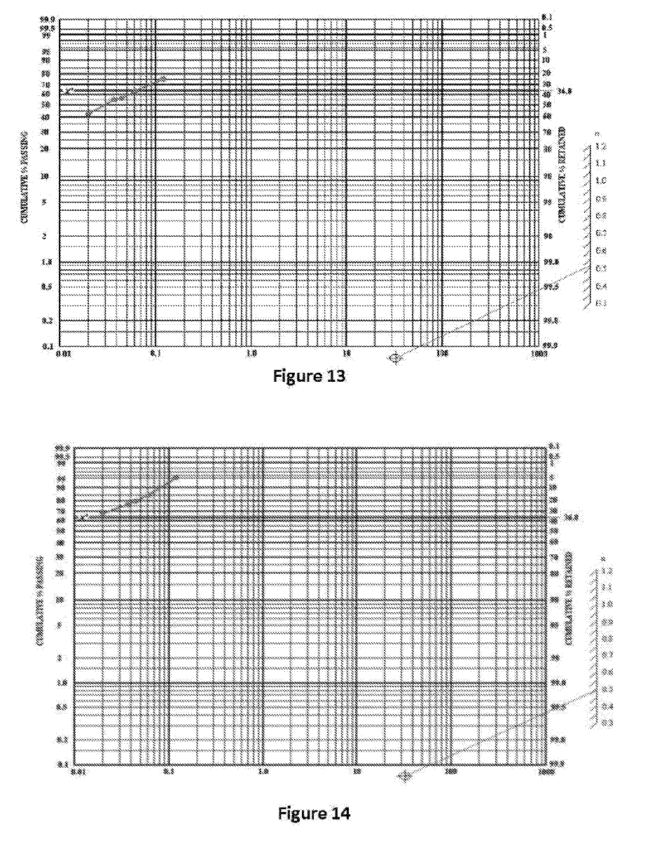

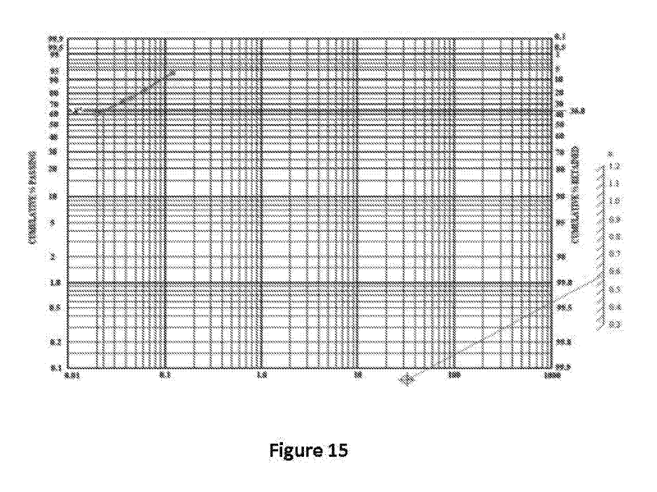

The results from an analysis of sample 4 also depicted graphically in FIG. 11 indicate that tailing samples with a particle size of greater than 0.02 mm (20 μm) result in recovering 40.2% of the tailing sample which was found to have a relatively low ash content of 18.5%. Similarly recovering tailing samples with a particle size of greater than 0.038 mm (38 μm) resulted in recovering 28.5% of the tailing sample which was found to have a relatively low ash content of 11.7%. Therefore, the applicants have theorised that separating and recovering particles from tailing dams having a particle size of equal to or greater than 0.02 mm (20 μm) and or greater than 0.038 mm (38 μm) in at least some embodiments, results in recovering a relatively high percentage of the initially samples tailings particles which advantageously have a relatively low ash content.

It is to be appreciated that whilst the preferred embodiment is directed towards separation of fine coal particles, the invention may be readily utilised for fines recovery of materials other than coal.

Any references to the term “ore” and “ore particles” in the specification non-exclusively and generally includes a naturally occurring solid material from which a metal or valuable mineral can be extracted profitably and encompass particles that may have been previously extracted or processed in an existing ore processing facility/plant. In the context of the present invention, “ore” is to be taken to include coal.

The term “processing plant” or “preparation plant” non-exclusively and generally refers to any facility that processes mined ore particles. Such processes may include washing the mined ore (that comprises rock and other impurities) and/or crushing/sorting the mined ore into smaller sized chunks.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1.-60. (canceled)

61. A transportable apparatus for separating and recovering fine particles from a mixture comprising the fine particles and other particles; the apparatus comprising a plurality of cyclone separators arranged in a first row for receiving a mixture of particles from a first source and a plurality of cyclone separators arranged in a second row for receiving a mixture of particles from the first source or from a second source, the first row of cyclone separators separating the mixture of particles into finer particles and coarser particles, the second row of cyclone separators separating the mixture of particles into finer particles and coarser particles.

62. A transportable apparatus as claimed in claim 61 wherein the first row of cyclones and the second row of cyclones are located within a closed container.

63. A transportable apparatus as claimed in claim 61 wherein the cyclone separators are configured for separating coarser particles having a particle size of greater than 15 μm from finer particles having a particle size of less than 15 μm.

64. A transportable apparatus as claimed in claim 63 wherein the cyclone separators are configured for separating coarser particles having a particle size of greater than 20 μm from finer particles having a particle size of less than 20 μm.

65. A transportable apparatus as claimed in claim 63 wherein the cyclone separators are configured for separating coarser particles having a particle size of greater than 25 μm from finer particles having a particle size of less than 25 μm.

66. A transportable apparatus as claimed claim 61 wherein the first row of cyclone separators produces an overflow stream and an underflow stream and the second row of cyclone separators produces an overflow stream and an underflow stream, the underflow stream from the first row of cyclone separators and the underflow stream from the second row of cyclone separators leaving the cyclone separators and moving into a common stream.

67. A transportable apparatus as claimed in claim 61 wherein the first row of cyclone separators produces an overflow stream and an underflow stream and the second row of cyclone separators produces an overflow stream and an underflow stream, the overflow stream from the first row of cyclones being removed by a first overflow pipe or passage, the overflow stream from the second row of cyclones being removed by a second overflow pipe or passage.

68. A transportable apparatus as claimed in claim 61 further comprising a vessel for holding a slurry comprising the mixture of particles.

69. A transportable apparatus as claimed in claim 68 wherein the second row of cyclone separators receive slurry form the vessel.

70. A transportable apparatus for recovering fine particles from a mixture comprising the fine particles and other particles, the apparatus comprising:
a transportable frame;
one or more cyclone separation chambers of a first type mounted in the transportable frame, said cyclone chamber adapted to receive an incoming stream containing the mixture, the cyclone being adapted for separating the stream into a first outgoing overflow stream comprising a slurry containing smaller separated particles and an underflow stream containing larger separated particles;
a vibration screen positioned relative to the one or more of the first type of cyclone separation chamber for receiving the underflow stream from the first type of cyclone and dewatering the underflow stream to obtain a dewatered underflow comprising screened particles;
a classifier positioned relative to the vibration screen for receiving the dewatered underflow and classifying the screened particles in the dewatered underflow by size or density to obtain classified particles;
a sump positioned for receiving the classified particles from the classifier; and
a cyclone separation chamber of a second type adapted to receive a stream comprising the classified particles from the sump for separating the stream comprising classified particles into an overflow output stream and an underflow output stream comprising thickened particles;
a centrifugal separator for receiving the underflow output stream from the cyclone separation chamber of the second type for separating the thickened fines and
a collector for collecting and directing the separated classified fines from the centrifugal separator to a stockpile.

71. A process for separating and recovering fine coal particles from a mixture comprising the fine coal particles and other particles, the process comprising the steps of
separating or classifying the fine coal particles having a particle size of at least greater than 15 μm and
recovering the separated or classified fine coal particles.

72. A process in accordance with claim 71 wherein coal particles having a particle size of greater than 20 μm are separated or classified and recovered thereafter.

73. A process in accordance with claim 71 wherein coal particles having a particle size of greater than 25 μm are separated or classified and recovered thereafter.

74. A process in accordance with claim 71 wherein the step of separating or classifying further comprises steps of forming a slurry comprising the mixture and subsequently directing the slurry to one or more fines separators and/or one or more fines classifiers.

75. A process in accordance with claim 74 wherein at least one of the separators comprises a cyclone separator such that the step of separating comprises directing the slurry to the cyclone separator and separating the slurry into an overflow stream comprising a slurry containing smaller particles having a particle size of less than or equal to 15 μm and an underflow stream comprising larger particles having a particle size of equal to or greater than 15 μm.

76. A process in accordance with claim 75 wherein at least one of the separators comprises a cyclone separator such that the step of separating comprises directing the slurry to the cyclone separator and separating the slurry into an overflow stream comprising a slurry containing smaller particles having a particle size of less than or equal to 20 μm and an underflow stream comprising larger particles having a particle size of equal to or greater than 20 μm.

77. A process in accordance with claim 75 wherein at least one of the separators comprises a cyclone separator such that the step of separating comprises directing the slurry to the cyclone separator and separating the slurry into an overflow stream comprising a slurry containing smaller particles having a particle size of less than or equal to 25 μm and an underflow stream comprising larger particles having a particle size of equal to or greater than 25 μm.

78. A process in accordance with claim 76 wherein the step of directing the slurry to the cyclone separator is carried out under a substantially constant pressure.

79. A process in accordance with claim 71 further comprising a step of receiving a stream comprising the recovered particles and directing the stream into a thickening cyclone and separating the stream into an overflow stream and an underflow thickened stream comprising fine thickened particles.

80. A process in accordance with claim 71 further comprising the step of analysing ash content of the separated and/or recovered fine particles.
